(19) United States
(12) Patent Application Publication
(10) Pub. No.: US 2023/0184183 A1
(43) Pub. Date: Jun. 15, 2023

(54) METHOD FOR CHECKING THE ASSOCIATION OF STRUCTURE-BORNE NOISE SENSORS WITH CYLINDERS OF AN INTERNAL COMBUSTION ENGINE

(71) Applicant: MTU FRIEDRICHSHAFEN GMBH, Friedrichshafen (DE)

(72) Inventors: Johannes BAUER, Hallerndorf (DE); Stephan BRENDLER, Ravensburg (DE); Frederik HAHN, Eriskirch (DE); Christoph Georg HUND, Tettnang (DE); Tim SPÄDER, Langenargen (DE); Patrick SPENGLER, Altenmünster (DE)

(21) Appl. No.: 16/063,578

(22) PCT Filed: Dec. 1, 2016
(86) PCT No.: PCT/EP2016/002030

§ 371 Date: Jun. 18, 2018

(30) Foreign Application Priority Data
Dec. 18, 2015 (DE) 10 2015 226 006.2

(51) Int. Cl. F02D 35/02; F02D 41/22; F02D 41/24; F02D 41/26

(52) U.S. Cl. CPC F02D 35/027; F02D 41/222; F02D 41/2474; F02D 41/26; F02D 2200/025

(57) ABSTRACT

A method for checking the association of structure-borne noise sensors of an internal combustion engine having a plurality of cylinders, which internal combustion engine can be operated in diesel operation or with individualized gas injection and in the case of which internal combustion engine a structure-borne noise sensor is arranged in the region of each cylinder, wherein the output signals of the structure-borne noise sensors reflect a knock index and are captured by a computing unit, wherein the internal combustion engine is operated in order to perform the method. The output signals of all structure-borne noise sensors are determined during at least one working cycle, which is formed by two revolutions of a crankshaft, in the respective positions of the crankshaft. The output signal of a cylinder is compared with the average value or the median value of the output signals of other cylinders.

The invention relates to a method for checking the association of structure-borne noise sensors of an internal combustion engine according to the features of the preamble of claim 1.

In particular, the invention relates to a method in which the association of structure-borne noise sensors with the respective cylinders of an internal combustion engine is checked. It is known from the prior art to associate a structure-borne noise sensor with each cylinder in internal combustion engines operated as diesel engines or which are operated with a cylinder-specific gas injection. The output signals of the individual structure-borne noise sensors supply a structure-borne noise signal from which a knocking index of each cylinder can be derived. These knocking indices are fed to a knocking control system which controls the operation of the individual cylinders, in particular the fuel injection or the ignition. This is done by suitable energization of a fuel injector or of a cylinder-specific gas valve in conjunction with an ignition unit. It is therefore possible to monitor the combustion by means of structure-borne noise sensors and, if appropriate, intervene actively in the combustion and avoid severe knocking. It is therefore possible to operate the internal combustion engine at the knocking limit. According to the invention, a knocking index is a variable which is acquired on the basis of the structure-borne noise signal and which permits conclusions to be drawn about the combustion or the pressure profile in the cylinder. In order to control these processes, a knocking module is used, to which in addition to the signals of the individual structure-borne noise sensors information about the rotational angle and therefore the position of the camshaft and/or of the crankshaft at the ignition time is fed.

In particular in the case of internal combustion engines with a relatively large number of cylinders there is the risk that the individual structure-borne noise sensors can be interchanged, in particular when cabling structure-borne noise sensors to the respective knocking module. There is the risk here of the structure-borne noise sensors being incorrectly associated as a result of incorrect cabling. The same issue also arises when the injectors or gas inlet valves are connected. These are also associated with the respective cylinder on an individualized basis.

If, as a result of interchanging of two or more structure-borne noise sensors, there is a fault in the association of the respective structure-borne noise sensor with the respective cylinder, a significantly quieter combustion noise is detected from the respective cylinder and is output by the structure-borne noise sensor. The reason for this is that as a result of the incorrect association to the engine controller or to the knocking module a value of a cylinder which is to be monitored at the time of the ignition is fed to the inactive cylinder. Since the knocking control system is active at this time, it attempts to equate this cylinder, which is actually to be monitored. This leads to excessively early ignition, which can in turn lead to considerable engine damage.

When the association of two injectors or individual gas inlet valves with a cylinder is interchanged, no combustion, or uncontrolled combustion, takes place at the affected cylinder. This fault is usually detected when the engine is put into operation, since the engine has striking true-running disruption and a non-uniform running noise. The fault also affects the cylinder-specific knocking signal which is fed to the knocking module or the engine controller.

The invention is based on the object of providing a method for checking the association of structure-borne noise sensors of an internal combustion engine, which method permits rapid and reliable fault detection which is carried out in an automated fashion and is easy to carry out for the operating personnel.

The object is achieved by means of the combination of features of claim 1, and the subclaims present further advantageous refinements.

A method for checking the association of structure-borne noise sensors of an internal combustion engine which can be operated in the diesel mode or with the individual gas injection and which has a plurality of cylinders is therefore provided, wherein the internal combustion engine is equipped with a structure-borne noise sensor in the region of each cylinder. The output signals of the individual structure-borne noise sensors which represent a knocking index are acquired and processed by means of a knocking module or by means of a computing unit which comprises an engine controller. In this context there can be provision that the internal combustion engine is operated with a stable load point to carry out the method. This stable load point can be reached, for example, by operating the internal combustion engine in the idling mode or, in particular in the case of steady-state internal combustion engines, by operation with a constant load point. However, there can also be a random load point. The knocking index is a variable which is acquired on the basis of the structure-borne noise signal and which permits conclusions to be drawn about the combustion or the pressure profile in the cylinder.

In the method, the output signals of all the structure-borne noise sensors are acquired in the respective positions of the crankshaft during at least one working cycle which is formed by two revolutions of a crankshaft. The respective output signal of the cylinder which is to be checked is compared below with an average (arithmetic mean) or a median value of the output signals of at least one other remaining cylinder. This comparison makes it possible to detect whether the correct structure-borne noise sensor is associated with the cylinder which is to be examined.

The method therefore makes it possible to check whether the values which are fed to the engine controller and/or the knocking module by the structure-borne noise sensors fit the cylinder which is to be respectively monitored. As a result, incorrect settings, in particular as a result of a knocking control system, which would otherwise give rise to damage to the internal combustion engine are avoided. It is therefore possible to check the plausibility of the signal of the structure-borne noise sensor so that it is also possible to adjust or calibrate the signals of the structure-borne noise sensors in accordance with the respective sensitivity of the sensor. In all cases it is ensured that the respective sensor values are associated correctly with the respective cylinders.

In a favorable development of the method there is provision that a knocking control system of the internal combustion engine is switched off while the method is being carried out. This avoids the signals which are output being falsified by the intervention of the knocking control system.

In order to ensure the steady-state operation of the internal combustion engine while the method is being carried out it is particularly advantageous if the method is carried out in the idling mode of the internal combustion engine or in a steady-state load state with a stable load point.

In one advantageous refinement of the method there is provision that the respective output signals of the structure-borne noise sensors are associated with the respective positions of the crankshaft and/or of the camshaft. This ensures that the cylinder which is to be respectively monitored is in an injection cycle or ignition cycle.

In one particularly favorable development of the method there is provision that an individual cylinder, specifically the cylinder which is to be examined, is switched off and the output signal of this switched-off cylinder is compared with the output signals of the structure-borne noise sensors of other cylinders. The switching off of the cylinder can be carried out, for example, by not energizing an injector by which fuel is injected. In the same way, with individual gas injection it is possible to interrupt the activation of the respective valve for feeding in gas.

In a development of the method there can be provision that a fault signal is output when the value of the output signal, for example the knocking index, of the cylinder which is to be checked is different than the average or the median value of the other cylinders. The average can be calculated as an average value. When a median value is used as a basis, for example the knocking indices of the other cylinders are listed according to their magnitude, and one of the average values of the list is determined as a median value.

Without switching off the cylinder which is to be checked, the fault signal is, for example output when the output signal of the cylinder which is to be checked is lower than the average or the median value, while in the case of a cylinder which is to be actively switched off a fault signal is output when the output signal or the knocking value of the cylinder which is to be checked is higher than the average or the median value of the other cylinders.

In order to increase the reliability of the method, it may be favorable if the method is carried out during a plurality of working cycles, and the values of the plurality of working cycles are taken into account.

A further measure for reducing faults can be to define the difference between the output signals of the cylinder which is to be respectively examined from the average or from the median value in such a way that it is, for example, at maximum 50%.

The method can be carried out automatically, for example while the internal combustion engine is operating, if the internal combustion engine is in one of the operating states described above. Furthermore, the method can be carried out successively for all the cylinders of the internal combustion engine.

The invention will be described below on the basis of exemplary embodiments in conjunction with the drawing, in which:

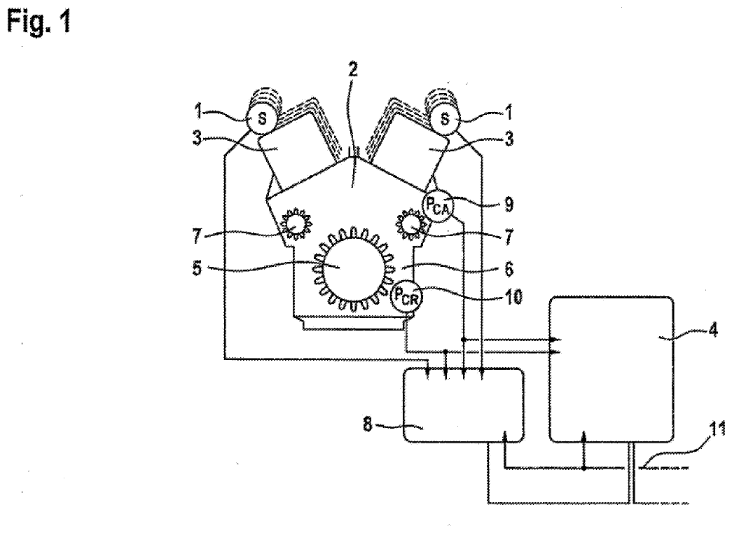

FIG. 1 shows a schematic illustration of an internal combustion engine 2 for carrying out the method,

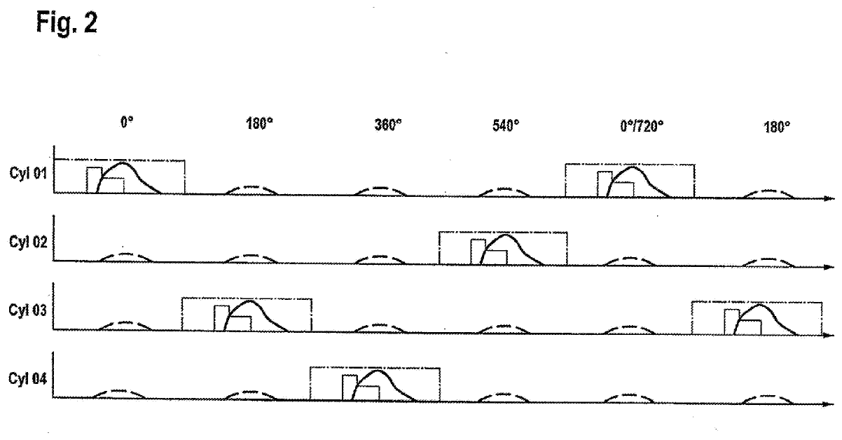

FIG. 2 shows an exemplary illustration of a four-cylinder internal combustion engine with a cylinder-specific structure-borne noise sensor system,

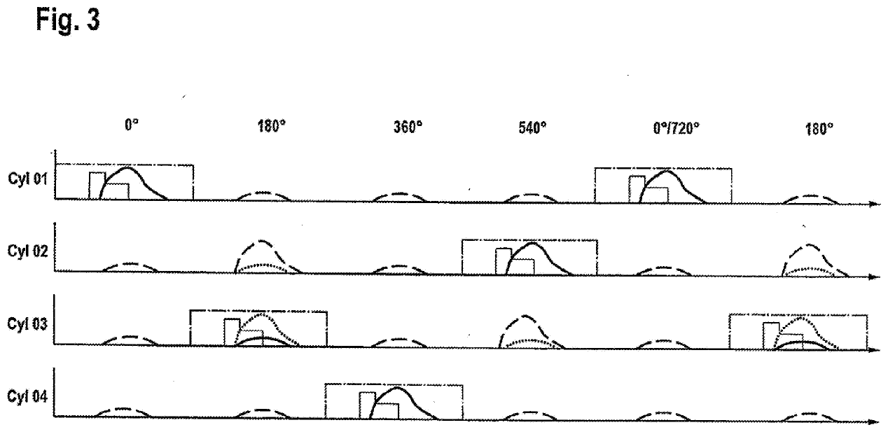

FIG. 3 shows an illustration, analogous to FIG. 2, of a first fault case when the association of two structure-borne noise sensors is interchanged,

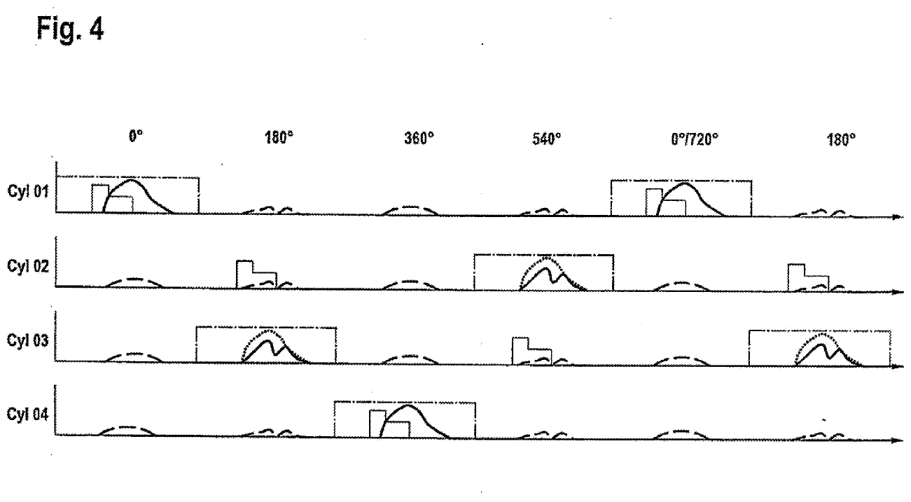

FIG. 4 shows an illustration, analogous to FIGS. 2 and 3, of a second fault case when the association of two injectors or gas inlet valves is interchanged,

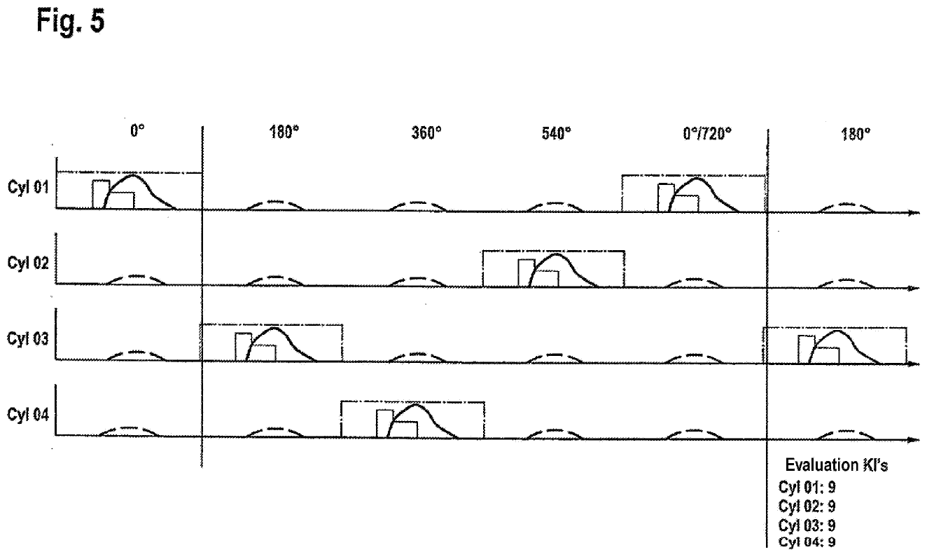

FIG. 5 shows a schematic illustration of a first exemplary embodiment of the method which is analogous to FIG. 2,

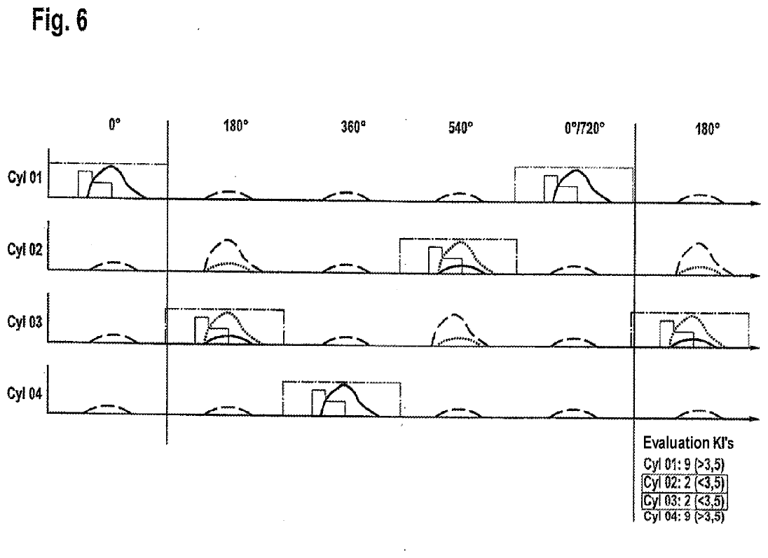

FIG. 6 shows an illustration, analogous to FIG. 5, with a faulty structure-borne noise sensor,

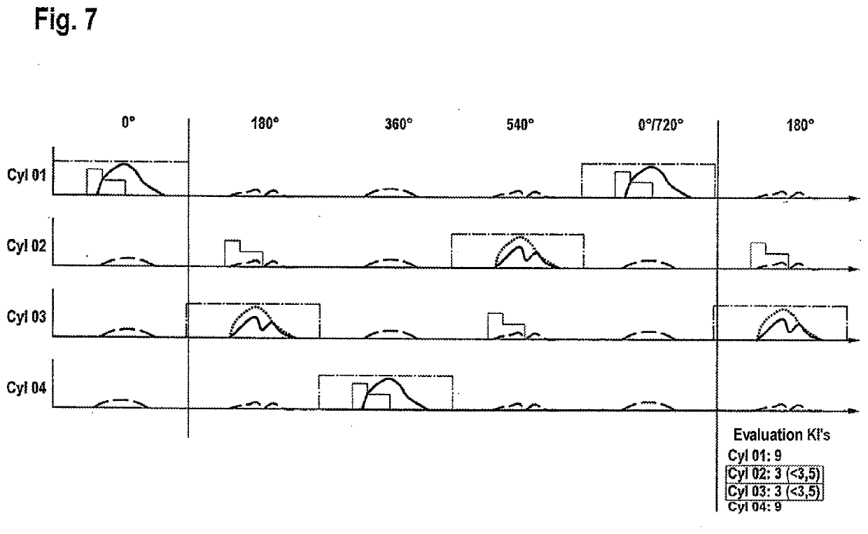

FIG. 7 shows an illustration, analogous to FIG. 5, with a faulty injector,

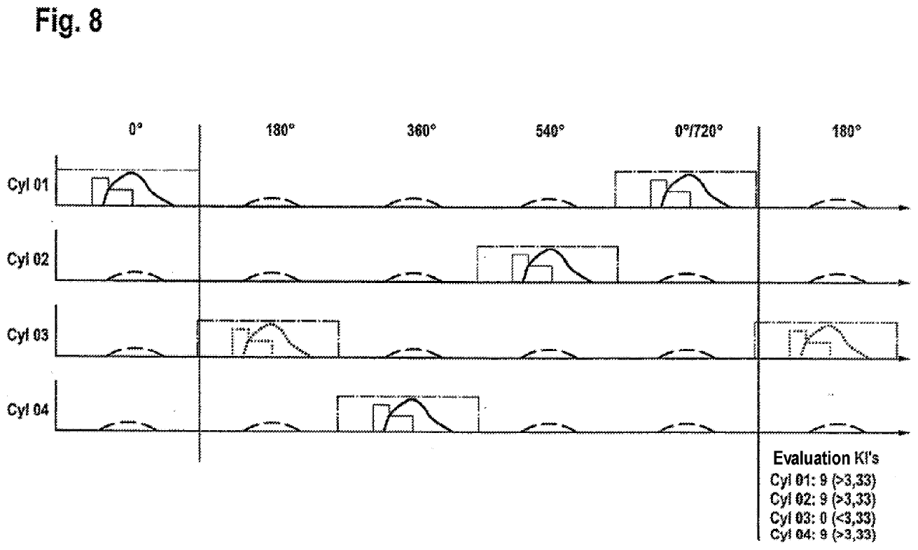

FIG. 8 shows an illustration, analogous to FIG. 2, of a method with active switching off of a cylinder,

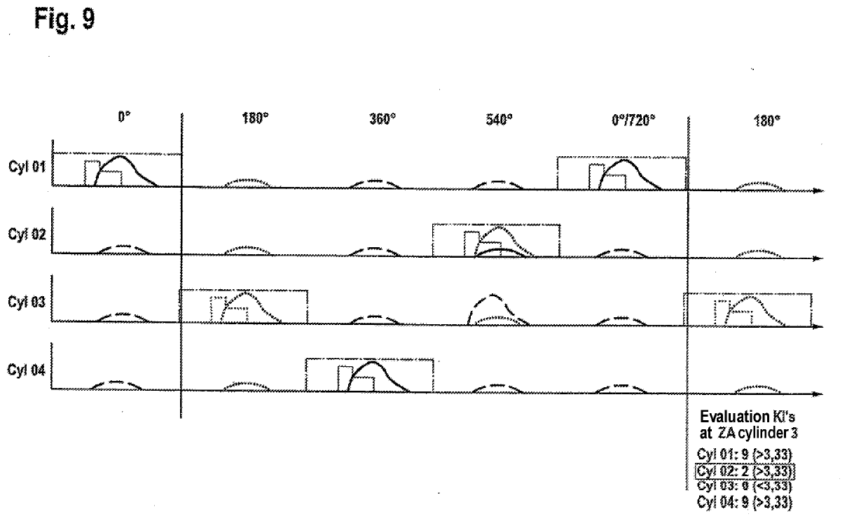

FIG. 9 shows an illustration, analogous to FIG. 8, with a faulty structure-borne noise sensor, and

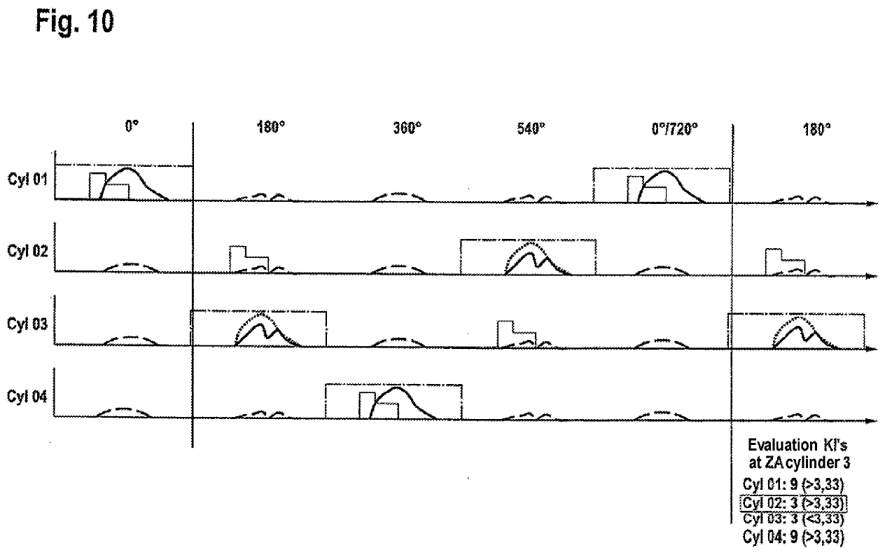

FIG. 10 shows an illustration, analogous to FIG. 8, with a faulty injector.

FIG. 1 shows a simplified illustration of an internal combustion engine 2 with two rows in which a plurality of cylinders 3 are arranged. A structure-borne noise sensor 1 is associated with each of the cylinders. The reference number 6 denotes an engine block in which a crankshaft is rotatably mounted. The reference number 7 denotes a camshaft. Furthermore, FIG. 1 shows a knock-detection module 8 (computing unit for structure-borne-noise-based knocking detection). The signals of the structure-borne noise sensors 1 are fed to the knocking module, as are the output signals of a camshaft sensor 9 (P_{CA} Pickup Sensor Camshaft) and of a crankshaft sensor 10 (P_{CR} Pickup Sensor Crankshaft). Furthermore, the output signals are fed to an engine controller/computing unit 4 (ECS Engine Control Systems). The reference number 11 denotes a power supply (Power supply 24 V DC). In the internal combustion engine shown in FIG. 1, the number of cylinders per row is for example ≤=12.

FIG. 2 shows a simplified illustration of the ignition sequences of four cylinders. The cylinders are illustrated together, wherein the ignition sequence is related to the angular position of the crankshaft. The first cylinder ignites at 0°, the third cylinder ignites at 180°, the fourth cylinder at 360° and the second cylinder at 540°. FIG. 2 therefore shows an exemplary illustration of a four-cylinder internal combustion engine with a cylinder-specific structure-borne noise sensor system. The internal combustion engine is in the steady-state operating mode. In a normal case/good case, the injection of fuel takes place per cylinder, and the structure-borne noise signal is acquired on a cylinder-specific basis. In this context, the dot-dash line shows the measuring window for the evaluation of a knocking signal which is output by the structure-borne noise sensor. Injector energization or cylinder-specific activation of a gas valve is represented schematically by the thin rectangular line representation. The continuous half sinusoidal curve shows a simplified illustration of the structure-borne noise signal of the cylinder which is respectively igniting or is to be examined. The arcuate signals which are shown outside the respective measuring windows and are illustrated with dashed lines each represent a structure-borne noise signal outside the measuring window, which signal results from other cylinders and is also acquired by the respective structure-borne noise sensor.

After the cylinder-specific structure-borne noise signal has been acquired, a cylinder-specific knocking index is determined on the basis of this structure-borne noise signal, wherein, as mentioned, only the structure-borne noise signal which is acquired in the measuring window of the respective cylinder is evaluated. Combustion noises of the adjacent cylinder which are represented by the dashed lines are gated out on the basis of the crankshaft angle. The knocking control takes place, as mentioned, as a function of the structure-borne noise signal. The individual cylinders are equated by intervention of the ignition by the knocking control system and are operated near to the knocking limit. Therefore, FIG. 2 represents the basic procedure of the acquisition of signals and the knocking control.

FIG. 3 shows an analogous illustration of a first fault case in which the association of two structure-borne noise sensors has been interchanged. Therefore, in each case a significantly quieter combustion noise is detected from the affected cylinders 2 and 3 whose structure-borne noise sensors have been interchanged. The setpoint noise is represented here by the dashed line in the measuring windows at 180° and 540°. In the respectively adjacent cylinder, the structure-borne noise is acquired in an attenuated fashion, as is shown, for example, in the case of cylinder 2 at 180° and in the case of cylinder 3 at 540°. An active knocking control system will attempt to equate the cylinders. The excessively early ignition which occurs here can result in considerable damage to the internal combustion engine. A further problem is that the actual structure-borne noise signal is not acquired. There is then no engine protection.

FIG. 4 shows a second fault case in which the fuel injectors of the cylinders 2 and 3 are interchanged with respect to their cabling. If there is a fault in the association of an injector or of a cylinder-specific gas valve with a cylinder, no combustion or uncontrolled combustion takes place at the respectively affected cylinder. This is also manifested in the respectively acquired values which are output by the structure-borne noise sensors. This fault case is generally detected by the operating personnel when the internal combustion engine is put into operation, since the internal combustion engine becomes noticeable through striking true-running disruption and/or a non-uniform running noise. This fault also acts on the cylinder-specific knocking signal and can be detected.

FIGS. 5 to 7 show, on the basis of a first exemplary embodiment, the application of the method for detecting a faulty association of the structure-borne noise sensors.

FIG. 5 is illustrated in an analogous fashion to FIG. 2, with the result that in this respect it is possible to dispense with a repeated description. From FIG. 2 it is clear that the knocking indices are evaluated per working cycle, corresponding to 720° crankshaft revolution at an operating point with a deactivated knocking control system and a stable load point, for example in the idling mode. A correct structure-borne noise signal gives rise to a knocking index of the respective cylinder which is higher by a predefined percentage, for example 50% than the average or the median of the other cylinders. If the knocking index of a cylinder is lower than a predefined percentage of the average or median of the knocking indices of the other cylinders of the respective working cycle over a plurality of working cycles, for example three working cycles, the cylinder association is detected as striking. If a cylinder association is striking over a plurality of working cycles, for example five working cycles, successively, the cylinder association is also detected as faulty.

FIGS. 6 and 7 show an analogous illustration of different fault cases; in FIG. 6 the structure-borne noise sensors of the cylinders 2 and 3 have been interchanged as a result of faults in the cabling while in the illustration in FIG. 7 the injectors or gas valves of the cylinders 2 and 3 have been interchanged as a result of faulty cabling. While, as illustrated in FIG. 5, the knocking indices KI each result in a value of 9, the situation according to FIG. 6 gives rise to knocking indices of 9, 2, 2 and 9. This results in a situation in which the knocking indices of the cylinders 2 and 3 are respectively lower than the average (less than 3.5), while the knocking indices of the cylinders 1 and 4 are larger than the average (higher than 3.5). In each case an operating point with a deactivated knocking control system, for example in the engine idling mode, is again used as the basis. The knocking indices are also evaluated here per working cycle for a crankshaft rotational angle of 720°, as shown by the vertical lines (see also FIG. 5). A correct structure-borne noise signal gives rise to a knocking index of each cylinder which is higher, by a predefined percentage, for example 50%, than that of the average or median of the other cylinders. If the knocking index of a cylinder is lower by a predefined percentage of the average or of the median of the knocking indices of the other cylinders of the respective working cycle over a plurality of working cycles, for example three working cycles, the cylinder association is detected as striking. In the case of detection as striking or faulty, a fault signal is output.

FIG. 6 shows, in contrast to FIG. 5, that the cylinders 2 and 3 each exhibit a too small knocking index, while in the case of the knocking index of the respectively adjacent cylinder an excessively large structure-borne noise signal occurs at the respective angular position of the crankshaft as a result of the transmission of noise between adjacent cylinders. This is verified by the profile curve of the structure-borne noise signal outside of the illustrated measuring window.

FIG. 7 shows a fault case in which the cabling of the injectors or individual gas valves of the cylinders 2 and 3 have been interchanged. This results in knocking indices of 9, 3, 3 and 9. It is also apparent here that the knocking indices of the cylinders 2 and 3 are lower than the averages or median values. Therefore, a small or significantly reduced structure-borne noise signal occurs at the crankshaft positions of 180° and 540°. The fault is also clearly apparent here.

FIGS. 8 to 10 show the situations of the individual cylinders in an analogous illustration, wherein in the exemplary embodiment according to FIG. 8 the cylinder 3 has been switched off. The injector and the individual gas feed valve have not been energized here. In this exemplary embodiment the switching off takes place in order to carry out the method, wherein the knocking control system is also deactivated here and the internal combustion engine is in the idling mode, for example. The knocking indices KI are also evaluated per working cycle (720° crankshaft angle) here. FIG. 8 shows only the switching off of a cylinder, and in the method one cylinder is switched off after the other, in each case for a plurality of working cycles, for example five working cycles.

A correct structure-borne noise signal gives rise to a knocking index of the switched-off cylinder (cylinder 3) which is lower than a predefined percentage value, for example 50%, of the average or median of the knocking indices of the other cylinders.

If the knocking index of a switched-off cylinder is higher than the predefined percentage value of the average or of the median of the knocking indices of the other cylinders of the respective working cycle, the cylinder association is detected as striking.

A correct structure-borne noise signal gives rise to a knocking index of the respectively active cylinder which reaches, for example, at least 50% of the average or median of the knocking indices of the other active cylinders. This is illustrated in FIG. 8, and knocking indices of 9, 9, 0 and 9 result.

If the knocking index of an active cylinder is lower during the switching off of another cylinder than a predefined percentage of the average or of the median value of the knocking indices of the other cylinders of the respective working cycle, the cylinder association of this cylinder is detected as striking.

In the method it is possible to reject a plurality of working cycles, for example the first two, and to evaluate the values of the subsequent working cycles, for example the working cycles 3, 4 and 5, with the cylinder switched off. If the association is striking in multiple instances, for example in two of the three working cycles, the cylinder association is detected as faulty.

FIG. 9 shows, in a way analogous to the illustration in FIG. 8, the execution of a method in which the cabling of the structure-borne noise sensor 2 and that of the structure-borne noise sensor 3 have been interchanged. The knocking control system is also deactivated again here, and the internal combustion engine is in the idling mode. The cylinders are switched off one after the other for a plurality of working cycles. This takes place, for example, through non-energization of the injector or of the gas inflow valve. FIG. 9 shows a situation in which the third cylinder is switched off. A correct structure-borne noise signal gives rise to a knocking index of the switched-off cylinder which is lower than a predefined percentage, for example less than 50% of the average or median of the knocking indices of the other cylinders which have not been switched off. If the knocking index of this cylinder is higher than a predefined percentage of the average or median of the knocking indices of the other cylinders of the respective working cycle over a plurality of working cycles, for example three working cycles, the cylinder association is detected as striking, and a fault signal is output. A correct structure-borne noise signal would give rise to a knocking index of the respectively active cylinder which is higher than a predefined percentage, for example 50%, of the average or median of the knocking indices of the other active cylinders. If the knocking index of an active cylinder is lower during the switching off of another cylinder over a plurality of working cycles, for example three working cycles, than a predefined percentage of the average or median value of the knocking indices of the other cylinders of the respective working cycle, the cylinder association is detected as striking and a fault signal is output. In the illustration in FIG. 9, knocking indices of 9, 2, 0 and 9 result. Therefore, the value of the cylinder 2 is below the predefined percentage value. Since the cylinder 3 has been switched off, a knocking index of 0 results.

FIG. 10 shows a variant in which the cabling of the injectors of cylinders 2 and 3 has been interchanged. In an illustration which is analogous to the situation in FIG. 9, knocking indices of 9, 3, 3 and 9 result. The knocking index of the second cylinder is higher here than the average or median of the knocking indices of the other cylinders by a predefined percentage. This gives rise to a fault message such as has been described above.

In the explanations above, a knocking index of 9 has been assumed as an ideal value, it goes without saying that the knocking index can fluctuate slightly within a plurality of working cycles. Furthermore, it becomes apparent that the method becomes more precise as the number of cylinders increases. At least two cylinders are necessary to carry out the method. The execution of the method and the checking of the plausibility of the values of the structure-borne noise sensors preferably occurs in the diesel operating mode in a dual fuel or bifuel internal combustion engine since the combustion of diesel is characteristic and permits a comparison between the individual cylinders. The combustion of an individual cylinder can be influenced directly by shutting off individual cylinders (an injector test can also be carried out in an analogous fashion). As a result, the reaction to the structure-borne noise signal which is output can be evaluated. Furthermore, the reaction between the individual cylinders can be compared. Since the structure-borne noise signal is evaluated only in a specific crankshaft angle range, this can be clearly associated with one cylinder.

The method therefore makes it possible to discover faults in the cabling and also to assess the sensitivity of the individual structure-borne noise sensors.

1-10. (canceled)

11. A method for checking association of structure-borne noise sensors of an internal combustion engine which can be operated in a diesel mode or with individual gas injection and which has a plurality of cylinders and a crankshaft, comprising the steps of: arranging a structure-borne noise sensor in a region of each cylinder, wherein output signals of the structure-borne noise sensors represent a knocking index; acquired the output signal by a computing unit; operating the internal combustion engine to carry out the method; acquiring the output signals of all the structure-borne noise sensors in respective positions of the crankshaft during at least one working cycle which is formed by two revolutions of the crankshaft; and comparing the respective output signal of a cylinder with an average value or a median value of the output signals of other cylinders.

12. The method according to claim 10, including switching off a knocking control system of the internal combustion engine while the method is being carried out.

13. The method according to claim 10, including operating the internal combustion engine in an idling mode while the method is being carried out.

14. The method according to claim 10, including switching off an individual cylinder, and comparing the output signal of the associated structure-borne noise sensor of the switched-off cylinder with another active cylinder which is not switched off.

15. The method according to claim 10, including outputting a fault signal when a value of the output signal of the cylinder which is to be checked is present which is different than the average value or median value of the other cylinders.

16. The method according to claim 15, including outputting a fault signal when the value of the output signal of the cylinder which is to be checked is lower than the average value or median value of the other cylinders.

17. The method according to claim 15, including outputting a fault signal when the value of the output signal of the cylinder which is to be checked is higher than the average value or median value of the other cylinders.

18. The method according to claim 10, including carrying out the method during a plurality of working cycles.

19. The method according to claim 10, wherein a difference between the output signals of the respective cylinder to be examined from the average value or median value of the respective other cylinders exceeds a portion of the average value or median value.

20. The method according to claim 10, including carrying out the method automatically and/or successively for all the cylinders.
